(19) United States
(12) Patent Application Publication
(10) Pub. No.: US 2020/0122335 A1
(43) Pub. Date: Apr. 23, 2020

(54) FOOD HOLDING APPARATUS AND METHOD FOR OPERATING THE SAME

(71) Applicant: KAWASAKI JUKOGYO KABUSHIKI KAISHA, Kobe-shi,Hyogo (JP)

(72) Inventors: Yukio IWASAKI, Kobe-shi (JP); Ippei NAGAHIRO, Kobe-shi (JP); Masashi MISAWA, Kakogawa-shi (JP); Kyo DAN, Akashi-shi (JP)

(73) Assignee: KAWASAKI JUKOGYO KABUSHIKI KAISHA, Kobe-shi, Hyogo (JP)

(21) Appl. No.: 16/605,487

(22) PCT Filed: Apr. 12, 2018
(86) PCT No.: PCT/JP2018/015378

§ 371 Date: Oct. 15, 2019

(30) Foreign Application Priority Data
Apr. 14, 2017 (JP) 2017-080781

(51) Int. Cl. B25J 11/00; B25J 15/08; B25J 15/00

(52) U.S. Cl. CPC B25J 11/0045; B25J 15/0033; B25J 15/08

(57) ABSTRACT

A food holding apparatus is a food holding apparatus configured to hold or release an ingredient. The food holding apparatus includes a base portion, a pair of arms drivably attached to the base portion, a pair of distal end portions respectively provided to distal ends of the pair of arms, and a control device configured to control an operation of the pair of arms. The control device is configured to control the operation of the pair of arms such that the pair of distal end portions hold the ingredient in an inner side between the distal end portions in a state of facing each other, and the pair of distal end portions release the ingredient held in the inner side between the distal end portions in a state of being separated from each other.

### TECHNICAL FIELD

The present invention relates to a food holding apparatus and a method for operating the same.

### BACKGROUND ART

In the related art, in a production site of food such as in-flight meals or lunch, a dishing work of food is performed by workers. The workers pick up a food container which is transported by, for example, a conveyor, by one hand, sprinkle a small amount of sesame over the food by the other hand while maintaining a predetermined posture of the food container, and after the work, release the food at a predetermined position on the conveyor.

In recent years, in various fields, it has been proposed that robots and workers work together in the same work space from the viewpoint of productivity improvement. In the production site of the food as described above, in a case where a humanoid work robot is introduced and the dishing work of the food is performed, measures for holding a fixed small amount of ingredients such as sesame and securely supplying the held ingredients to the top of the food are necessary. PTL 1 discloses a food dishing robot. As examples of a food container supported by the food dishing robot, a container having a V-shaped notch as a spout of granular food, and a container having a projection such as a distal end of a kettle as a spout of liquid food are disclosed. The robot tilts the container to take the food out of the container. PTL 2 discloses a seasoning supply device. The seasoning supply device uniformly adds seasoning to semi-finished products (food such as confectionery). The seasoning supply device is configured to send (discharge) powdery seasoning such as salt from a distal end of a screw feeder. A plurality of through-holes are provided to a predetermined front portion of a cylindrical rotation shaft of the screw feeder.

### CITATION LIST

### Patent Literature

PTL 1: JP 2003-128002 A

PTL 2: JP 2015-223151 A

### SUMMARY OF INVENTION

### Technical Problem

However, in PTL 1, a work of filling a container with food by a worker is necessary. That is, the robot can supply food, but the robot itself cannot hold the food. In addition, the seasoning supply device of PTL 2 is used to a confectionery production system for producing confectionery such as potato chips. Therefore, the confectionery production system includes not only the seasoning supply device but also a combination weighing device, a packaging machine, a supply device, a discharge conveyor, and a chute. The entire system becomes complicated. In addition, the installation space is also increased.

The present invention is made to solve the above-described problems, and an object of the present invention is to securely hold or release a fixed small amount of ingredients such as sesame with a simpler configuration.

### Solution to Problem

In order to achieve the above-described object, a food holding apparatus according to an aspect of the present invention is a food holding apparatus configured to hold or release an ingredient. The food holding apparatus includes a base portion, a pair of arms drivably attached to the base portion, a pair of distal end portions respectively provided to distal ends of the pair of arms, and a control device configured to control an operation of the pair of arms, in which the control device is configured to control the operation of the pair of arms such that the pair of distal end portions hold the ingredient in an inner side between the pair of distal end portions in a state of facing each other, and the pair of distal end portions release the ingredient held in the inner side between the pair of distal end portions in a state of being separated from each other.

With the above configuration, in a state where the pair of distal end portions face each other, the ingredient (for example, sesame) is held in the inner side between the distal end portions, and the ingredient can be transported to a predetermined position. Then, the pair of distal end portions are separated from each other, so that the ingredient held in the inner side between the distal end portions is released, and thus the ingredient can be dished on the food (for example, parsley).

The pair of distal end portions may include recesses, the recesses may form a hollow portion in a state of facing each other, and the ingredient may be held in the inner side of the hollow portion.

With the above configuration, since the pair of distal end portions form the hollow portion in a state of facing each other, and the ingredient can be held in the inner side of the hollow portion, it is easy to hold a fixed small amount of ingredient. In addition, by appropriately changing the volume of the hemisphere, the amount of the ingredient to be held can be adjusted. The recess may be formed in a hemispherical shape, and the hollow portion may be formed in a spherical shape.

In addition, the pair of distal end portions may be formed in a complementary shape, and the complementary shape may be configured to hold the ingredient in an inner side between facing surfaces by mutual overlapping of the facing surfaces.

With the above configuration, since the pair of distal end portions are formed in the complementary shape, and the ingredient is held in the inner side between the facing surfaces by mutual overlapping of the facing surfaces, it is easy to hold a fixed small amount of ingredient. The complementary shape may have a flat plate shape. For example, by appropriately changing the area of the flat plate, the amount of the ingredient to be held can be adjusted.

The pair of arms may be configured such that in a posture in which the ingredient is held by the pair of distal end portions, positions of the pair of distal end portions of the pair of arms and positions of proximal end portions of the pair of arms are separated in a horizontal direction.

With the above configuration, for example, in a case of holding the ingredient accommodated in the container, in the horizontal direction, the positions of the distal end portions of the arms are aligned within the container, and the positions of the proximal end portions of the arms can be aligned outside the container. In this manner, even in a case where slight foreign matters such as dust are generated in a driving portion (proximal end portion) during the operation of the arms, it is possible to prevent the foreign matters from being dropped into the container to be mixed with the ingredient. For example, a part including the distal end portion of the arm may extend in a vertical direction, and a part including the proximal end portion of the arm may extend in the horizontal direction. Further, a body of the arm including the distal end portion and the proximal end portion may extend in an oblique direction with respect to the vertical direction. The ingredient may be a liquid or powdered ingredient.

A method for operating a food holding apparatus according to another aspect of the present invention is a method for operating a food holding apparatus including a base portion, a pair of arms drivably attached to the base portion, a pair of distal end portions respectively provided to distal ends of the pair of arms, and a control device configured to control an operation of the pair of arms. The method includes by controlling the operation of the pair of arms, holding the ingredient in an inner side between the pair of distal end portions in a state where the pair of distal end portions face each other, and releasing the ingredient held in the inner side between the pair of distal end portions in a state where the pair of distal end portions are separated from each other.

### Advantageous Effects of Invention

The present invention has the above-described configurations, and it is possible to securely hold or release a fixed small amount of ingredients such as sesame with a simpler configuration.

### BRIEF DESCRIPTION OF DRAWINGS

FIG. 1 is a view illustrating a schematic configuration of an industrial robot according to an embodiment of the present invention.

FIG. 2 is a side view of an end effector according to the embodiment of the present invention.

FIG. 3 is a plan view of a base hand and an adapter of an expansion tool, which is gripped by the base hand, of the end effector of FIG. 2.

FIG. 4 is a front view of the end effector illustrated in FIG. 2.

FIG. 5 is a partial sectional view of a distal end portion of the end effector illustrated in FIG. 4.

FIG. 6 is a functional block diagram schematically illustrating a configuration of a control device.

FIG. 7 is a schematic view illustrating an operation of the end effector.

FIG. 8 is a side view of an end effector according to a first modification example of the present invention.

FIG. 9 is a view illustrating an operation of an end effector according to a second modification example of the present invention.

### DESCRIPTION OF EMBODIMENTS

Hereinafter, preferred embodiments will be described with reference to the drawings. In the following, the same or corresponding elements are denoted by the same reference numerals in all of the drawings, and the redundant description thereof will be omitted. In addition, the drawings schematically illustrate the respective constituent elements in order to facilitate understanding.

### Embodiment

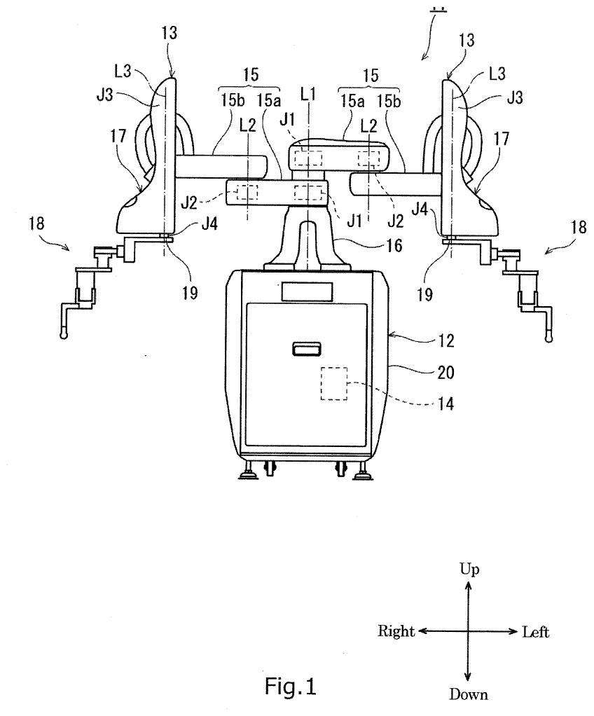

FIG. 1 is a view illustrating a schematic configuration of an industrial robot according to an embodiment of the present invention. As illustrated in FIG. 1, a robot 11 includes a base 12 fixed to a carriage, a pair of robot arms (hereinafter, simply described as “arms” in some cases) 13 and 13 supported by the base 12, and a control device 14 housed in the base 12. The robot 11 can be installed in a limited space (for example, 610 mm×620 mm) corresponding to one person.

Hereinafter, a direction in which a pair of arms are extended is referred to as a right and left direction. A direction parallel to a shaft center of a base shaft is referred to as an up and down direction. A direction orthogonal to the right and left direction and the up and down direction is referred to as a front and rear direction. The robot 11 of the present embodiment is applied to a production site of food, and performs a dishing work of food.

Each arm 13 is a horizontal articulated robot arm configured to be movable in a horizontal direction with respect to the base 12. Each arm 13 includes an arm section 15, a wrist section 17, and an end effector 18. The right arm 13 and the left arm 13 may have substantially the same structure. In addition, the right arm 13 and the left arm 13 can be independently operated or can be operated in conjunction with each other.

In the present example, the arm section 15 is configured of a first link 15a and a second link 15b. The first link 15a is connected to a base shaft 16 fixed to an upper surface of the base 12 by a rotational joint J1. The first link 15a is rotatable around a rotation axis L1 passing through a shaft center of the base shaft 16. The second link 15b is connected to a distal end of the first link 15a by a rotational joint J2. The second link 15b is rotatable around a rotation axis L2 defined in the distal end of the first link 15a.

The wrist section 17 includes a mechanical interface 19 to which the end effector 18 is attached. The wrist section 17 is connected to a distal end of the second link 15b by a linear joint J3 and a rotational joint J4. The wrist section 17 is movable up and down with respect to the second link 15b by the linear joint J3. The wrist section 17 is rotatable around a rotation axis L3 orthogonal to the second link 15b by the rotational joint J4.

The end effector 18 is connected to the mechanical interface 19 of each of the right and left wrist sections 17. The end effector 18 is provided to a distal end of each of the right and left arms 13. In the present embodiment, the right and left end effectors 18 have the same structure. The robot 11 to which the end effector 18 is applied is not limited to the present embodiment, and it is sufficient that the robot 11 is an industrial robot including at least one robot arm.

Each arm 13 having the above-described configuration includes the joints J1 to J4. Then, the arm 13 is provided with a servo motor (not illustrated) for driving, an encoder (not illustrated) for detecting a rotation angle of the servo motor, and the like to correspond to the joints J1 to J4. In addition, the rotation axis L1 of the first links 15a and 15a of two arms 13 and 13 are on the same straight line, and the first link 15a of one arm 13 and the first link 15a of the other arm 13 are disposed with a height difference in the up and down direction.

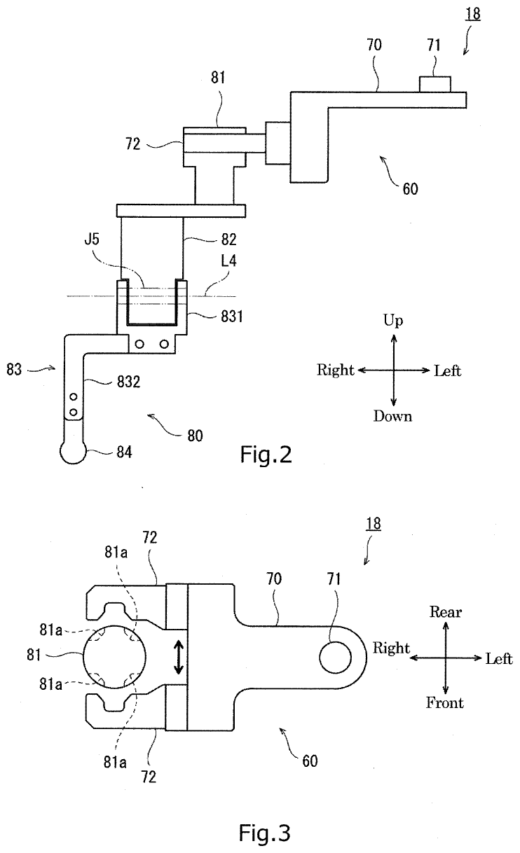

Next, the end effector 18 attached to the wrist section 17 of the arm 13 will be described. Since the right and left end effectors 18 have the same structure, only one (right) end effector is described here. FIG. 2 is a side view of the end effector 18. FIG. 3 is a plan view of a base hand 60 and an adapter 81 gripped by the base hand 60.

As illustrated in FIG. 2, the end effector 18 is configured of the base hand 60 and an expansion tool 80. The base hand 60 is an end effector (robot hand) capable of gripping an object. In the present embodiment, as the base hand 60, a gripper end effector which grips an object by a pair of fingers 72 that are translated while parallelism is maintained is adopted. However, the base hand 60 is not limited thereto, and the number of fingers and the degree of freedom are not limited as long as the base hand is an end effector capable of gripping an object. For example, as the base hand 60, an angle opening/closing gripper provided with a pair of rotating fingers, a robot hand that grips an object by three or more fingers, a chuck that restrains an object, and the like may be adopted.

As illustrated in FIGS. 2 and 3, the base hand 60 according to the present embodiment includes a platform 70 and the pair of fingers 72 driven by an actuator (not illustrated) supported by the platform 70. A robot interface 71 is provided to the platform 70. The robot interface 71 is coupled to the mechanical interface 19 (refer to FIG. 1) provided to the wrist section 17 of the arm 13.

The pair of parallel fingers 72 are driven by the actuator (not illustrated), and are moved to be translated so as to approach to or be separated from each other while parallelism is maintained. The actuator may be configured of, for example, an air cylinder, a linear motion mechanism, and the like (neither is illustrated).

The expansion tool 80 expands a gripping function of the base hand 60. The expansion tool 80 is configured to hold or release an object (ingredient). The expansion tool 80 includes the adapter 81, a base portion 82 coupled to the adapter 81, a pair of holding arms 83 drivably attached to the base portion 82, a pair of distal end portions 84 respectively provided to distal ends of the pair of holding arms 83.

The adapter 81 is a connection portion between the base hand 60 and the expansion tool 80. The adapter 81 is gripped by the base hand 60 so that the expansion tool 80 and the base hand 60 are connected. An upper portion of the adapter 81 has a columnar shape or a cylindrical shape. Hereinafter, an extension direction of the columnar or cylindrical shaft center is referred to as a “shaft center direction” (up and down direction in FIGS. 2 and 3). Engagement portions 81a engaging with the fingers 72 of the base hand 60 are provided on an outer circumferential surface of the adapter 81. The engagement portions 81a correspond to the number and positions of fingers of the base hand 60.

The base hand 60 according to the present embodiment includes the pair of fingers 72, and the engagement portions 81a corresponding to the fingers are grooves formed on the outer circumferential surface of the adapter 81. When the adapter 81 formed with the grooves is sandwiched by the pair of fingers 72 from both sides, the pair of fingers 72 are fitted into the grooves to become an aspect in which the pair of fingers 72 bite into the outer circumferential surface of the adapter 81.

The width of the groove which is the engagement portion 81a is the same as or slightly larger than the width (thickness) of the finger 72. In this manner, the pair of fingers 72 engage with the engagement portions 81a. That is, the pair of fingers 72 are fitted into the grooves so that the position in the shaft center direction and the rotational position of the adapter 81 with respect to the base hand 60 are determined.

The base portion 82 is coupled to the adapter 81, and includes two rotational joints J5 having a rotation axis L4 in a direction (right and left direction in FIG. 2) orthogonal to the shaft center direction of the adapter 81. The two rotational joints J5 are driven by an actuator (not illustrated). The actuator may be configured of, for example, an air cylinder.

The holding arm 83 is configured of a proximal end portion 831, an intermediate portion 832, and a distal end portion 84 (refer to FIG. 2). The proximal end portion 831 is connected to the base portion 82 by the rotational joint J5. The proximal end portion 831 is rotatable around the rotation axis L4 passing through a shaft center of the rotational joint J5. A portion, which includes the proximal end portion 831, of the intermediate portion 832 extends in a horizontal direction. A portion, which includes the distal end portion 84, of the intermediate portion 832 extends in a vertical direction. That is, the pair of holding arms 83 are configured such that the position of the distal end portion 84 and the position of the proximal end portion 831 are separated from each other in the horizontal direction (right and left direction in FIG. 2) in a posture in which an object (ingredient) is held by the pair of distal end portions 84.

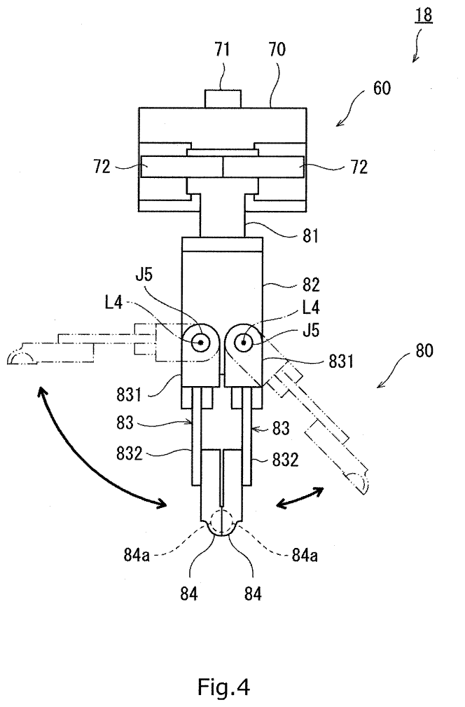

FIG. 4 is a front view of the end effector 18. As illustrated in FIG. 4, the holding arms 83 can be opened or closed around the rotation axis L4 such that the longitudinal direction of the holding arm 83 is at any angle with respect to the vertical direction. In the present embodiment, the holding arms 83 are controlled to be stopped in two states of a state in which the holding arms 83 are opened around the rotation axis L4 such that the longitudinal direction of the holding arm 83 is at an angle of 60 degrees with respect to the vertical direction and a state in which the holding arms 83 are closed such that the longitudinal direction of the holding arm 83 is at an angle of 0 degrees with respect to the vertical direction.

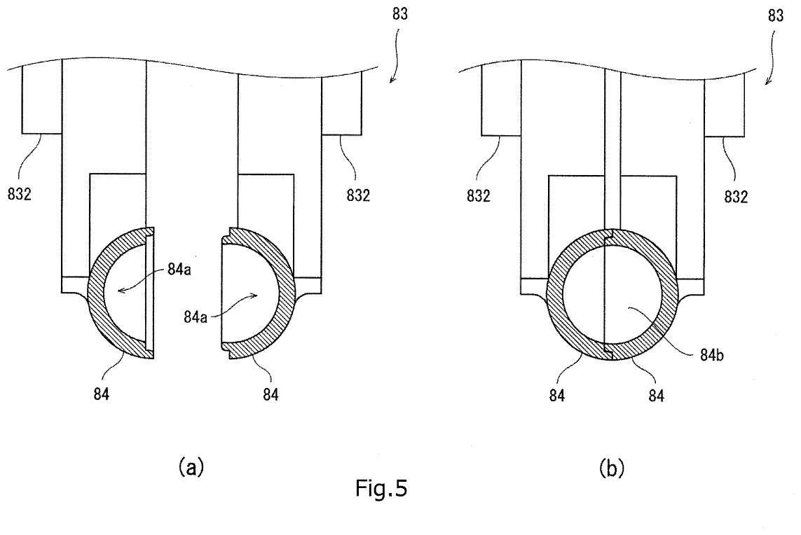

FIG. 5 is a partial sectional view of the distal end portion 84 of the end effector 18. As illustrated in FIG. 5, each distal end portion 84 has a hemispherical recess 84a. In the present embodiment, the hemispherical recesses 84a form a spherical hollow portion 84b in a state of facing each other. That is, the pair of distal end portions 84 are configured to hold an object (ingredient) in an inner side between the distal end portions in a state of facing each other. In addition, the pair of distal end portions 84 are configured to release the object (ingredient) held in the inner side between the distal end portions in a state of being separated from each other.

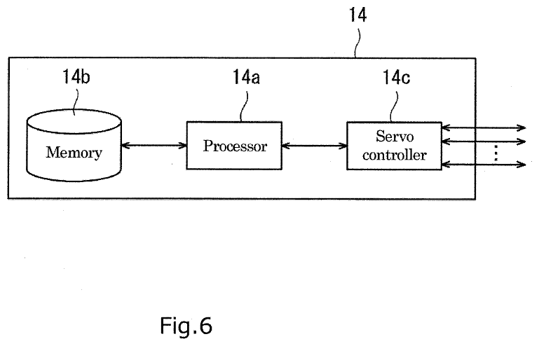

FIG. 6 is a functional block diagram schematically illustrating a configuration of the control device 14 (refer to FIG. 2) of the robot 11. As illustrated in FIG. 6, the control device 14 includes an processor 14a such as a CPU, a memory 14b such as ROM or RAM, and a servo controller 14c. The control device 14 is, for example, a robot controller including a computer such as a microcontroller. The control device 14 may be configured of a single control device 14 for centralized control, or may be configured of a plurality of control devices 14 for distributed control in cooperation with each other.

Information such as a basic program as the robot controller and various items of fixed data is stored in the memory 14b. The processor 14a controls various operations of the robot 11 by reading and executing software such as the basic program stored in the memory 14b. That is, the processor 14a generates a control command for the robot 11 and outputs the control command to the servo controller 14c. The servo controller 14c is configured to control the driving of the servo motor corresponding to the joints J1 to J4 of each arm 13 of the robot 11 on the basis of the control command generated by the processor 14a. In addition, the holding operation (refer to FIG. 2) of the adapter 81 and the opening/closing operation (refer to FIG. 4) of the holding arms 83 of the expansion tool 80 by the base hand 60 are also controlled by the control device 6. Accordingly, the control device 14 controls the entire operation of the robot 11.

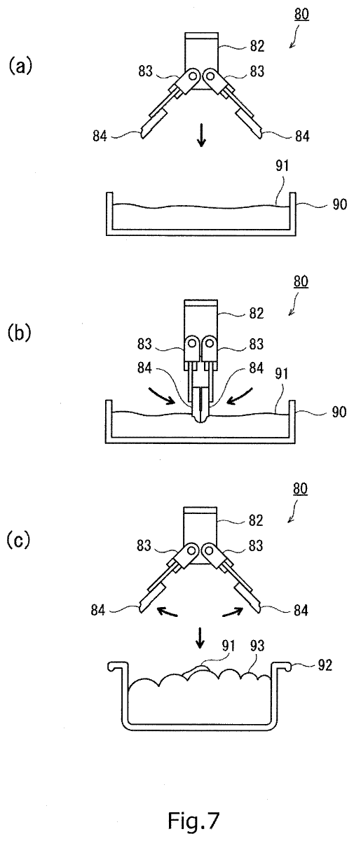

Next, an example of the operation of the robot 11 controlled by the control device 14 will be described using FIG. 7. The robot 11 of the present embodiment holds an ingredient 91, and performs a dishing work on food 93. In the present embodiment, the ingredient 91 is sesame powder. The ingredient 91 is not limited to a powdered ingredient, and may be a liquid ingredient such as a sauce or a dressing. In addition, the food 93 is, for example, parsley, but is not limited thereto.

Specifically, the control device 14 controls the operation of the arm 13 so that the adapter 81 is held by the base hand 60 of the end effector 18 and the holding arms 83 of the expansion tool 80 are opened. Then, as illustrated in FIG. 7(a), in a state where the holding arms 83 of the expansion tool 80 are opened, the expansion tool 80 is moved to be in the vicinity just above the tray container 90 in which the ingredient 91 is accommodated.

Then, as illustrated in FIG. 7(b), the control device 14 performs control so that the expansion tool 80 is lowered and the pair of holding arms 83 are closed. In this manner, the pair of distal end portions 84 hold the ingredient 91 in an inner side between the distal end portions in a state of facing each other.

Thereafter, as illustrated in FIG. 7(c), the control device 14 performs control so that the pair of holding arms 83 are opened in the vicinity just above a container 92 in which the food 93 is accommodated. By the pair of distal end portions 84 being separated from each other, the ingredient 91 held in the inner side between the distal end portions is released. In this manner, it is possible to dish the ingredient 91 on the food 93 in the container 92.

In addition, in the present embodiment, the pair of distal end portions 84 have hemispherical recesses 84a, the hemispheres form the spherical hollow portion 84b in a state of facing each other, and the ingredient is held in the hollow portion 84b. Thus, it is easy to hold a fixed small amount of ingredient 91. Furthermore, by appropriately changing the volume of the hemisphere, the amount of the ingredient to be held can be adjusted.

Note that the recess 84a is formed in a hemispherical shape, but is not limited thereto as long as the ingredient can be held in an inner side between the recesses in a state where the recesses face each other.

In addition, in the present embodiment, in a posture in which the ingredient 91 is held by the pair of distal end portions 84, the positions of the distal end portions 84 of the pair of holding arms 83 and the positions of the proximal end portions 831 of the pair of holding arms 83 are configured to be separated in the horizontal direction (refer to FIG. 2). In this manner, in a case of holding the ingredient 91 accommodated in the container 90 (refer to FIG. 7), in the horizontal direction, the positions of the distal end portions 84 of the holding arms 83 are aligned to be within the container 90, and the positions of the proximal end portions 831 of the holding arms 83 can be aligned to be out of the container 90. In this manner, even in a case where slight foreign matters such as dust are generated in the driving portion (proximal end portion) during the operation of the holding arm 83, it is possible to prevent the foreign matters from being dropped into the container 90 to be mixed with the ingredient 91. Note that, in the present embodiment, a configuration is adopted in which the intermediate portion 832 including the distal end portion 84 of the holding arm 83 extends in the vertical direction and a portion including the proximal end portion 831 extends in the horizontal direction (refer to FIG. 2), but the body of the holding arm 83 including the distal end portion 84 and the proximal end portion 831 may extend in an oblique direction with respect to the vertical direction.

### Modification Examples

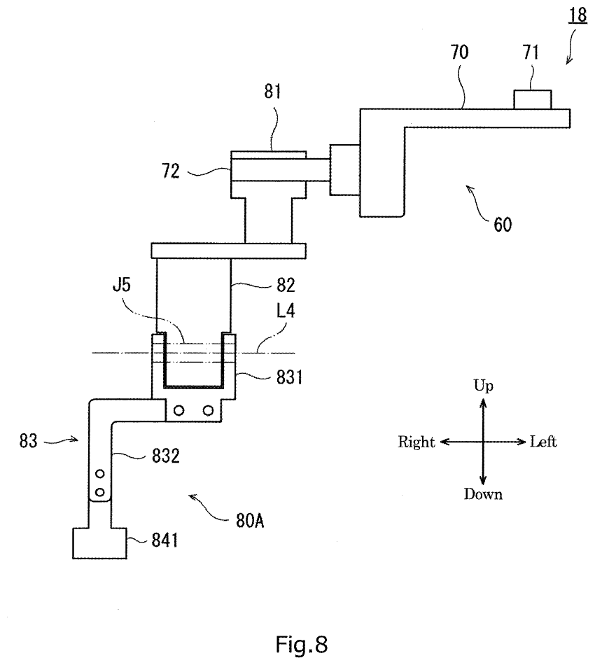

FIG. 8 is a side view of an end effector according to a modification example of the present invention. As illustrated in FIG. 8, an expansion tool 80A of the present modification example is different from that of the embodiment in that a pair of distal end portions 841 have flat plate shapes. The flat plate shapes are configured to hold an object (ingredient) in an inner side between facing surfaces thereof by the facing surfaces being overlapped. In this manner, by appropriately changing the area of the flat plate, the amount of the ingredient to be held can be adjusted. Note that, the pair of distal end portions 841 may have, for example, curved surface shapes as long as the distal end portions are formed in a complementary shape. Even with such a configuration, it is possible to hold an object (ingredient) in an inner side between facing curved surfaces by the facing curved surfaces being overlapped.

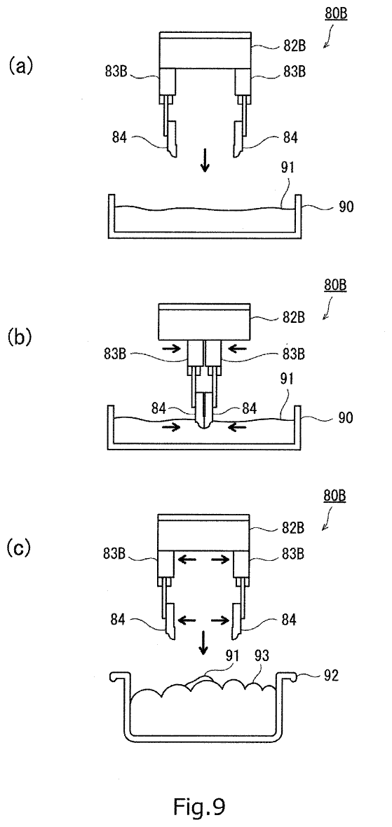

FIG. 9 is a schematic view illustrating an operation of an end effector according to a second modification example of the present invention. As illustrated in FIG. 9, an expansion tool 80B of the present modification example is different from that of the embodiment in that each holding arm 83B is configured to be movable in parallel with a base portion 82B. The pair of holding arms 83B are driven by an actuator (not illustrated), and are moved to be translated so as to approach to or be separated from each other while parallelism is maintained. Even with such a configuration, as illustrated in FIGS. 9(a) to 9(c), the pair of distal end portions 84 can hold the ingredient 91 in an inner side between the distal end portions in a state of facing each other, and by the pair of distal end portions 84 being separated from each other, the ingredient 91 held in the inner side between the distal end portions can be released. Note that, the distal end portion 84 in FIG. 9 may have a flat plate shape (841) as in FIG. 8.

### Other Embodiments

In the above-described embodiment, the dishing work of the food is performed by the double arm robot 11, but may be realized by a dedicated apparatus which includes the end effector 18 and can perform positioning control.

The robot 11 of the above-described embodiment is the horizontal articulated double arm robot, but may be a vertical articulated robot as long as the robot includes the expansion tool 80 at a distal end of the robot arm.

In the above-described embodiment, the expansion tool 80 is configured to be held by the base hand 60, but the expansion tool 80 may be directly attached to the mechanical interface 19 at the distal end of the robot arm 13.

Many modifications and other embodiments of the present invention are apparent to those skilled in the art from the above description. Accordingly, the above description should be construed as illustrative only and is provided for the purpose of teaching those skilled in the art the best modes for carrying out the present invention. The details of the structures and/or the functions can be substantially changed without departing from the spirit of the present invention.

### INDUSTRIAL APPLICABILITY

The present invention is useful in the production site of food such as in-flight meals or lunch.

### REFERENCE SIGNS LIST

11 robot
13 robot arm
14 control device
18 end effector
60 base hand
80 expansion tool
82 base portion
83 holding arm
84 distal end portion
84a recess
84b hollow portion
90 container
91 ingredient (sesame)
92 container
93 food (parsley)

1. A food holding apparatus configured to hold or release an ingredient, the food holding apparatus comprising:
a base portion;
a pair of arms drivably attached to the base portion;
a pair of distal end portions respectively provided to distal ends of the pair of arms; and
a control device configured to control an operation of the pair of arms, wherein
the control device is configured to control the operation of the pair of arms such that the pair of distal end portions hold the ingredient in an inner side between the pair of distal end portions in a state of facing each other, and the pair of distal end portions release the ingredient held in the inner side between the pair of distal end portions in a state of being separated from each other.

2. The food holding apparatus according to claim 1, wherein
the pair of distal end portions include recesses,
the recesses form a hollow portion in a state of facing each other, and
the ingredient is held in an inner side of the hollow portion.

3. The food holding apparatus according to claim 2, wherein
each recess is formed in a hemispherical shape, and
the hollow portion is formed in a spherical shape.

4. The food holding apparatus according to claim 1, wherein
the pair of distal end portions are formed in a complementary shape, and
the complementary shape is configured to hold the ingredient in an inner side between facing surfaces by mutual overlapping of the facing surfaces.

5. The food holding apparatus according to claim 4, wherein the complementary shape has a flat plate shape.

6. The food holding apparatus according to claim 1, wherein the pair of arms are configured such that in a posture in which the ingredient is held by the pair of distal end portions, positions of the pair of distal end portions of the pair of arms and positions of proximal end portions of the pair of arms are separated in a horizontal direction.

7. The food holding apparatus according to claim 1, wherein the ingredient is a liquid or powdered ingredient.

8. A method for operating a food holding apparatus including a base portion, a pair of arms drivably attached to the base portion, a pair of distal end portions respectively provided to distal ends of the pair of arms, and a control device configured to control an operation of the pair of arms, the method comprising:
by controlling the operation of the pair of arms,
holding the ingredient in an inner side between the pair of distal end portions in a state where the pair of distal end portions face each other; and
releasing the ingredient held in the inner side between the pair of distal end portions in a state where the pair of distal end portions are separated from each other.

9. The food holding apparatus according to claim 2, wherein the pair of arms are configured such that in a posture in which the ingredient is held by the pair of distal end portions, positions of the pair of distal end portions of the pair of arms and positions of proximal end portions of the pair of arms are separated in a horizontal direction.

10. The food holding apparatus according to claim 3, wherein the pair of arms are configured such that in a posture in which the ingredient is held by the pair of distal end portions, positions of the pair of distal end portions of the pair of arms and positions of proximal end portions of the pair of arms are separated in a horizontal direction.

11. The food holding apparatus according to claim 4, wherein the pair of arms are configured such that in a posture in which the ingredient is held by the pair of distal end portions, positions of the pair of distal end portions of the pair of arms and positions of proximal end portions of the pair of arms are separated in a horizontal direction.

12. The food holding apparatus according to claim 5, wherein the pair of arms are configured such that in a posture in which the ingredient is held by the pair of distal end portions, positions of the pair of distal end portions of the pair of arms and positions of proximal end portions of the pair of arms are separated in a horizontal direction.

13. The food holding apparatus according to claim 2, wherein the ingredient is a liquid or powdered ingredient.

14. The food holding apparatus according to claim 3, wherein the ingredient is a liquid or powdered ingredient.

15. The food holding apparatus according to claim 4, wherein the ingredient is a liquid or powdered ingredient.

16. The food holding apparatus according to claim 5, wherein the ingredient is a liquid or powdered ingredient.

17. The food holding apparatus according to claim 6, wherein the ingredient is a liquid or powdered ingredient.
